(19) United States
(12) Patent Application Publication
(10) Pub. No.: US 2026/0099044 A1
(43) Pub. Date: Apr. 9, 2026

(54) LENS MODULE AND ELECTRONIC DEVICE FOR IMPROVING AN IMAGE QUALITY OF THE LENS MODULE

(71) Applicant: Newmax Technology Co., Ltd., Taichung City (TW)

(72) Inventors: Yung-Fu LIANG, Taichung City (TW); Chiung-Hung CHEN, Taichung City (TW)

(21) Appl. No.: 18/991,323

(22) Filed: Dec. 20, 2024

(30) Foreign Application Priority Data
Oct. 7, 2024 (TW) 113138163

(51) Int. Cl. G02B 27/00; G02B 5/00; G02B 7/02; G02B 13/00; H04N 23/54; H04N 23/55

(52) U.S. Cl. CPC G02B 27/0018; G02B 5/005; G02B 7/02; G02B 13/0055; H04N 23/54; H04N 23/55

(57) ABSTRACT

A lens module includes: a lens barrel; an optical lens assembly disposed in the lens barrel, wherein the optical lens assembly includes at least one lens; an optical spacer disposed in the lens barrel and located on an object-side surface of the lens; and an optical sensor disposed in the lens barrel and located on an image plane; wherein the optical spacer includes an annular body having an outer periphery and an inner periphery, the outer periphery surrounds the inner periphery, and an opening is formed around the inner periphery; and the outer periphery includes first and second cut edges, which are respectively contracted toward a center of the optical spacer along the Y-axis, and the inner periphery includes third and fourth cut edges, which are respectively contracted toward the center of the optical spacer along the Y-axis.

This application claims the benefit of Taiwan Patent Application No. 113138163, filed on Oct. 7, 2024, which is hereby incorporated by reference for all purposes as if fully set forth herein.

### BACKGROUND

### Technical Field

The present disclosure relates to a lens module, and in particular to an electronic device having a lens module.

### Related Art

The shooting function is already an indispensable function for terminal electronic devices (such as mobile phones, laptops, tablets, etc.). In order to obtain good image quality and camera effects, lens modules are installed in electronic devices to provide an extensive shooting function. Electronic devices emphasize the ratio of screen to body, and the front of a general electronic device not only has the display screen, but also has components such as front lens modules, which affects the ratio of screen to body according to the electronic device.

Currently, lightness, thinness and narrow frame of electronic devices are industry development needs. The lens module is usually disposed on the frame of the display screen of the electronic device. Since the lens module has a certain height and width, when the lens module is disposed on the frame of the display screen of the electronic device, it is difficult for the electronic device to achieve a narrow frame. The narrow frame will also increase the thickness of the electronic device and makes the electronic device difficult to achieve thinness and lightness.

An imaging circle of the lens module is usually larger than the size of the optical sensor, and currently it is a major design trend to contract the lens module in the specific direction to increase the ratio of screen to body. However, when the lens module 9 (shown in FIG. 1) in the prior art is contracted in the specific direction, additional stray light may be generated, for example stray light hits the outside of the lens at a large angle.

Thus, a lens module and an electronic device need to be provided for meeting previous requirements.

### SUMMARY

An objective of the present disclosure is to provide an optical spacer of a lens module, which has a non-traditional annular structure in a specific direction.

To achieve the above objective, the present disclosure provides a lens module, defining a central axis, an X axis, a Y axis, an object side and an image side, wherein the central axis, the X axis and the Y axis are perpendicular to each other, the image side is opposite to the object side, and the lens module comprises: a lens barrel; an optical lens assembly disposed in the lens barrel, wherein the optical lens assembly includes at least one lens; an optical spacer disposed in the lens barrel and located on an object-side surface of the lens; and an optical sensor disposed in the lens barrel and located on an image plane; wherein the optical spacer includes an annular body having an outer periphery and an inner periphery, the outer periphery surrounds the inner periphery, and an opening is formed around the inner periphery; the outer periphery includes first and second cut edges, which are respectively contracted toward a center of the optical spacer along the Y-axis, and the inner periphery includes third and fourth cut edges, which are respectively contracted toward the center of the optical spacer along the Y-axis; and the distance between the first and second cut edges is D2, the distance between the third and fourth cut edges is D1, and the following conditions are satisfied: 0.05≤D1/D2≤0.95.

The present disclosure further provides an electronic device, comprising: a housing; the above-mentioned lens module disposed in the housing, and a control component disposed in the housing and electrically connected to the optical sensor.

The optical spacer of the present disclosure has a non-traditional annular structure in a specific direction, which can solve the stray light in the specific direction of the Y-axis or the X-axis and improve an image quality of the lens module.

### BRIEF DESCRIPTION OF THE DRAWINGS

FIG. 1 is a schematic sectional view of a lens module in the prior art.

FIG. 2 is a schematic sectional view of a lens module according to an embodiment of the present disclosure.

FIG. 3 is a schematic exploded perspective view of a lens module according to an embodiment of the present disclosure.

FIG. 4 is a schematic front view of a lens module according to an embodiment of the present disclosure.

FIG. 5 is a schematic perspective view of an optical spacer of a lens module according to an embodiment of the present disclosure.

FIG. 5a is a schematic plan view of the optical spacer of the lens module according to the first embodiment of the present disclosure.

FIG. 5b is a schematic plan view of the optical spacer of the lens module according to the second embodiment of the present disclosure.

FIG. 5c is a schematic plan view of the optical spacer of the lens module according to the third embodiment of the present disclosure.

FIG. 5d is a schematic plan view of the optical spacer of the lens module according to the fourth embodiment of the present disclosure.

FIG. 5e is a schematic plan view of the optical spacer of the lens module according to the fifth embodiment of the present disclosure.

FIG. 5f is a schematic plan view of the optical spacer of the lens module according to the sixth embodiment of the present disclosure.

FIG. 5g is a schematic plan view of the optical spacer of the lens module according to the seventh embodiment of the present disclosure.

FIG. 5h is a schematic plan view of the optical spacer of the lens module according to the eighth embodiment of the present disclosure.

FIG. 5i is a schematic plan view of the optical spacer of the lens module according to the ninth embodiment of the present disclosure.

FIG. 6a to FIG. 6d are schematic diagrams showing four relationships between the size of the optical sensor and an imaging area of the lens module according to an embodiment of the present disclosure.

FIG. 7a to FIG. 7e are schematic diagrams comparing the lens module in the prior art with the lens module in other embodiments of the present disclosure.

FIG. 8 is a schematic sectional view of an electronic device according to an embodiment of the present disclosure.

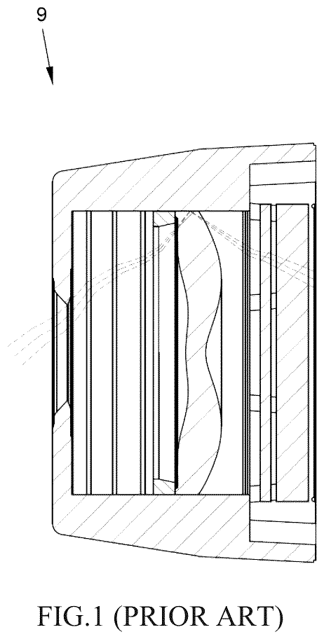

### DETAILED DESCRIPTION

To make the foregoing objectives, characteristics and features of the present disclosure more comprehensible, preferred embodiments of the present disclosure are described in detail below with reference to the accompanying drawings.

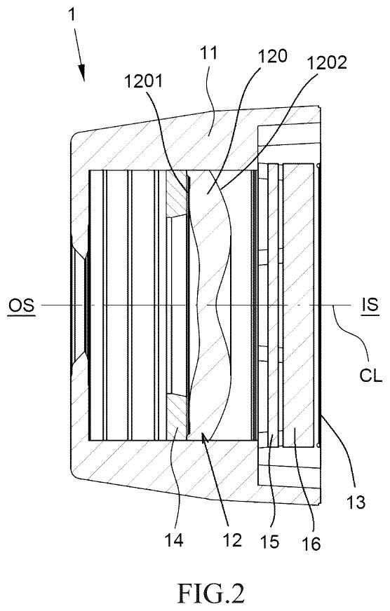

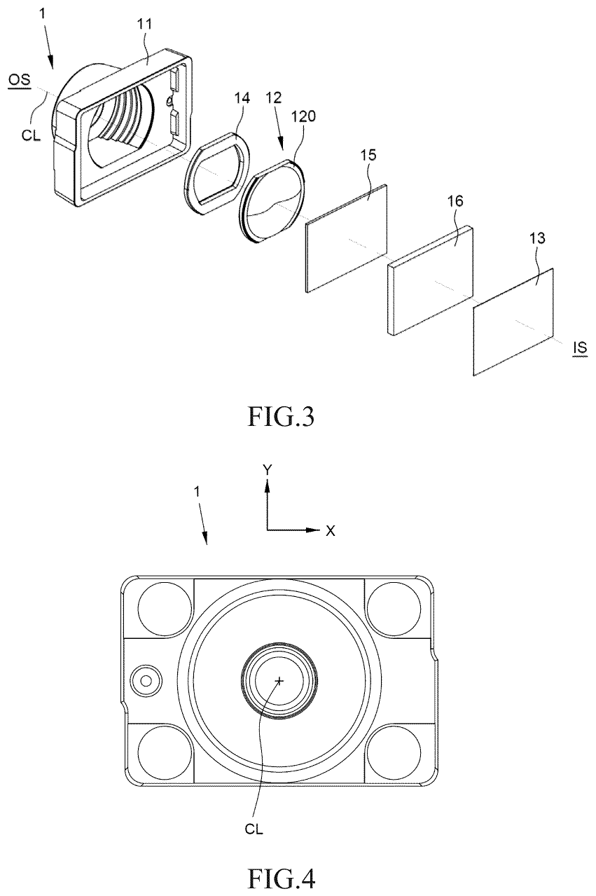

FIG. 2 is a schematic sectional view of a lens module according to an embodiment of the present disclosure. FIG. 3 is a schematic exploded perspective view of a lens module according to an embodiment of the present disclosure. FIG. 4 is a schematic front view of a lens module according to an embodiment of the present disclosure. Referring to FIG. 2, FIG. 3 and FIG. 4, the lens module 1 defines a central axis CL, an X axis, a Y axis, an object side OS and an image side IS. The central axis CL, the X axis, the Y axes are perpendicular to each other, and the image side IS is opposite to the object side OS. The lens module 1 includes: a lens barrel 11, an optical lens assembly 12, an optical spacer 14 and an optical sensor 13.

Refer to FIG. 2 and FIG. 3 again, the optical lens assembly 12 is disposed in the lens barrel 11, wherein the optical lens assembly 12 includes at least one lens 120. For example, the optical lens assembly 12 includes a plurality of lenses 120, such as a first lens to an N-th lens. The N-th lens is the lens of the optical lens assembly 12 that is the closest to the image side IS, and N is an integer greater than zero. The optical spacer 14 is disposed in the lens barrel 11 and located on an object-side surface 1201 of the lens 120. In this embodiment, the optical spacer 14 (e.g., as a spacer ring between the lens 120 and the lens 120) can be located in a non-optical area of the object-side surface 1201 of the lens 120. The lens module 1 further includes a plurality of optical elements arranged in the lens barrel 11, and the optical elements can be an optical filter (such as an infrared optical filter, an infrared bandpass optical filter, or other optical band filters, etc.) or a light-shielding element (for example, an aperture stop or a stop configured to correct edge light), or the like.

The optical sensor 13 is disposed in the lens barrel 11 and is located on an image plane. The optical sensor 13 may be an image sensor. The lens module 1 further includes: an optical filter 15 and a protective glass sheet 16, which are sequentially disposed between the optical lens assembly 12 and the optical sensor 13.

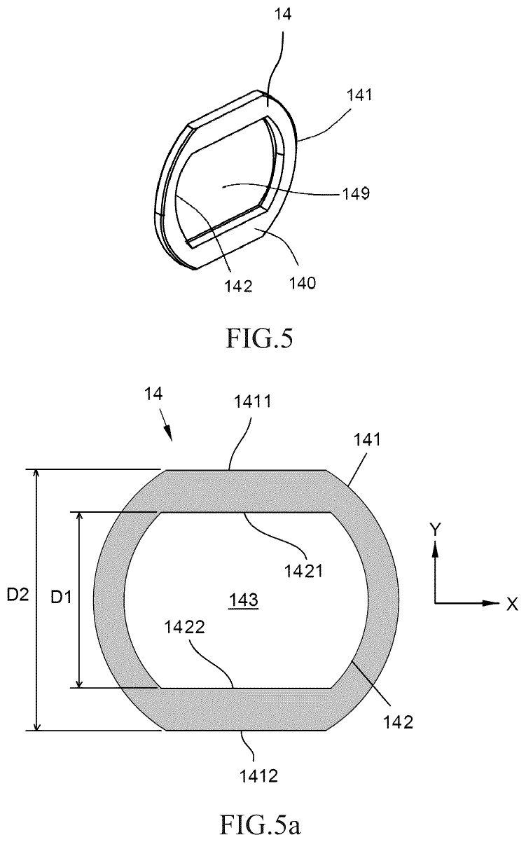

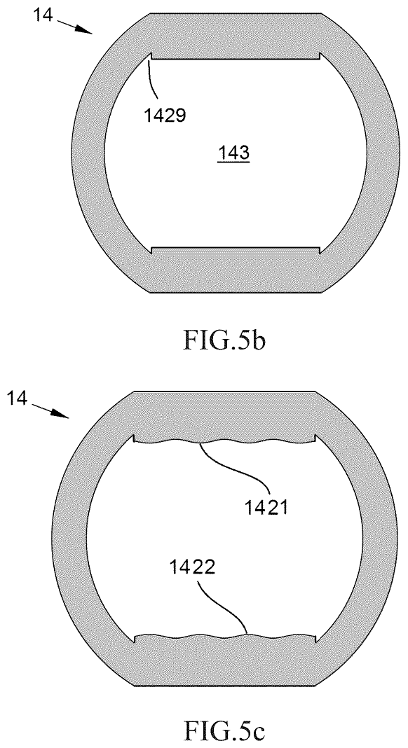

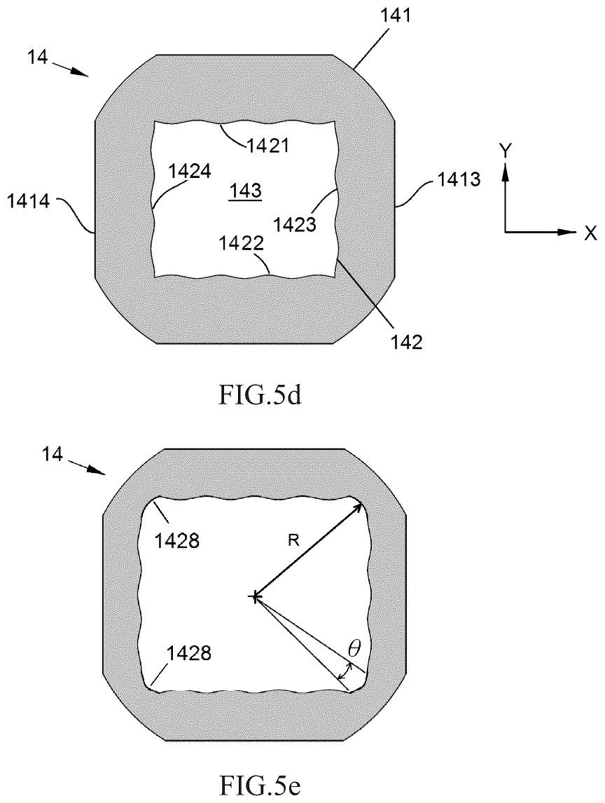

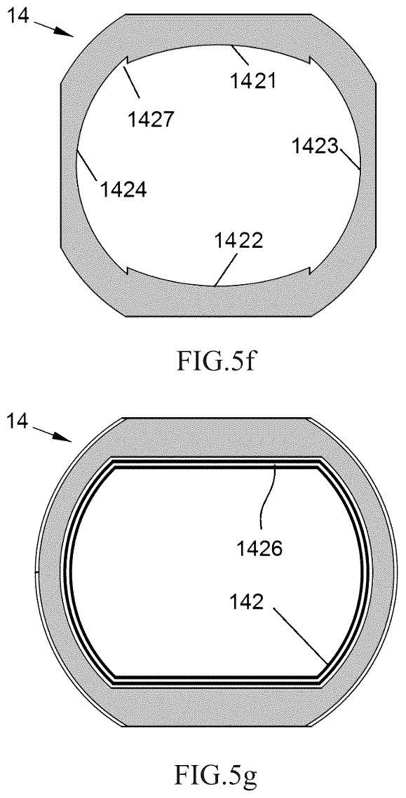

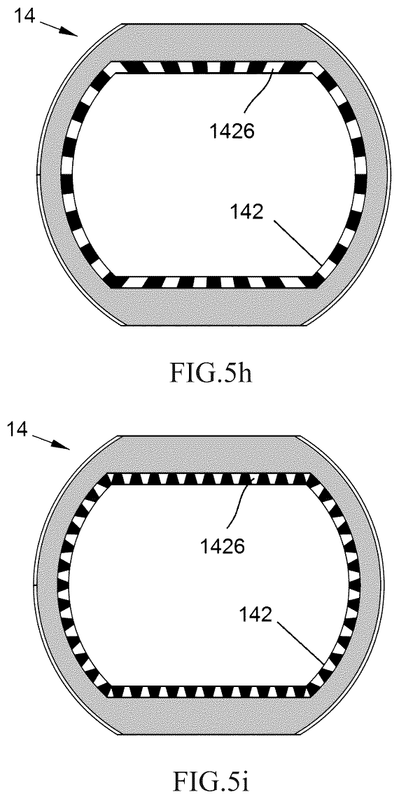

FIG. 5 is a schematic perspective view of an optical spacer of a lens module according to an embodiment of the present disclosure. FIG. 5a is a schematic plan view of the optical spacer of the lens module according to the first embodiment of the present disclosure. Referring to FIG. 5 and FIG. 5a, the optical spacer 14 includes an annular body 140 having an outer periphery 141 and an inner periphery 142. The outer periphery 141 surrounds the inner periphery 142, and an opening 149 is formed around the inner periphery 142; the outer periphery 141 includes a first cut edge 1411 and a second cut edge 1412, which are respectively contracted along the Y axis toward the center 143 (i.e., the position close to the central axis CL in FIG. 4) of the optical spacer 14, the inner periphery 142 includes a third cut edge 1421 and a fourth cut edge 1422, which are respectively contracted toward the center 143 of the optical spacer 14 along the Y-axis; and, the distance between the first cut edge 1411 and the second cut edge 1412 is D2, and the distance between the third cut edge 1421 and the fourth cut edge 1422 is D1, and the following conditions are satisfied: 0.05≤D1/D2≤0.95. All of the first to fourth cut sides 1411, 1412, 1421, and 1422 have a flat surface. The distance D2 between the first cut edge 1411 and the second cut edge 1412 is between 2.670±0.267 mm, but not limited thereto; preferably, the distance D2 is 2.67 mm. The distance D1 between the third cut edge 1421 and the fourth cut edge 1422 is between 1.737±0.174 mm, but not limited thereto; preferably, the distance D1 is 1.737 mm.

Since the lens module in the prior art is contracted along the Y-axis, additional stray light may be generated, for example, stray light hits the outside of the lens at a large angle. The design of the optical spacer of the present disclosure can block this large-angle stray light to solve the problem of the additional stray light generated by the lens module, thereby improving an image quality of the lens module.

FIG. 5b is a schematic plan view of the optical spacer of the lens module according to the second embodiment of the present disclosure. Referring to FIG. 5 and FIG. 5b, the optical spacer 14 in the second embodiment is generally similar to the optical spacer 14 in the first embodiment. The difference is that the inner periphery further includes four corners 1429, each of which respectively expands in opposite directions toward the center 143 of the optical spacer 14 to form a transmission portion. The transmission portion can solve the problem of RI (relative illumination) and vignetting.

FIG. 5c is a schematic plan view of the optical spacer of the lens module according to the third embodiment of the present disclosure. Referring to FIG. 5 and FIG. 5c, the optical spacer 14 in the third embodiment is generally similar to the optical spacer 14 of the second embodiment. The difference is that the third cut edge 1421 and the fourth cut edge 1422 have a wavy surface, which can scatter light to solve the problem of the stray light, thereby improving an image quality of the lens module.

FIG. 5d is a schematic plan view of the optical spacer of the lens module according to the fourth embodiment of the present disclosure. Referring to FIG. 5 and FIG. 5d, the optical spacer 14 in the fourth embodiment is substantially similar to the optical spacer 14 in the first embodiment. The difference is that the outer periphery 141 further includes a fifth cut edge 1413 and a sixth cut edges 1414, which are respectively contracted toward the center 143 of the optical spacer 14 along the X-axis, and the inner spacer further includes a seventh cut edge 1423 and an eighth cut edge 1424, which are respectively contracted toward the center 143 of the optical spacer 14 along the X-axis. All of the third cut edge 1421, the fourth cut edge 1422, the seventh cut edge 1423 and the eighth cut edge 1424 have a wavy surface, which can scatter light to solve the problem of stray light. In order to save space in the lens module of the prior art, the lens module of the present disclosure is also contracted along the X-axis, which may also produce additional stray light. However, the optical spacer of the present disclosure can be used to block the stray light, thereby improving an image quality of the lens module.

FIG. 5e is a schematic plan view of the optical spacer of the lens module according to the fifth embodiment of the present disclosure. Referring to FIG. 5 and FIG. 5e, the optical spacer 14 in the fifth embodiment is substantially similar to the optical spacer 14 in the fourth embodiment. The difference is that the inner periphery 142 further includes four corners 1428, which respectively form diagonal arcs. For example, the arc radius is R, and the following conditions are satisfied: 0.03 mm≤R≤∞. The central angle of the arc is θ, and the following conditions are satisfied: 10°≤θ≤80°.

FIG. 5f is a schematic plan view of the optical spacer of the lens module according to the sixth embodiment of the present disclosure. Referring to FIG. 5 and FIG. 5f, the optical spacer 14 in the sixth embodiment is substantially similar to the optical spacer 14 in the fourth embodiment. The difference is that all of the third cut edge 1421, the fourth cut edge 1422, the seventh cut edge 1423 and the eighth cut edge 1424 have an arc-shaped surface, and the inner periphery 142 further includes four corners 1427, which respectively expand in opposite directions toward the center 143 of the optical spacer 14 to form transmission portions. The transmissive portions can solve the problems of RI (Relative Illumination) and vignetting.

FIG. 5g is a schematic plan view of the optical spacer of the lens module according to the seventh embodiment of the present disclosure. Referring to FIG. 5 and FIG. 5g, the inner periphery 142 of the optical spacer 14 includes an inner surface 1426 (e.g., an inclined surface), which is provided with concentric annular microstructures. FIG. 5h is a schematic plan view of the optical spacer of the lens module according to the eighth embodiment of the present disclosure. Referring to FIG. 5 and FIG. 5h, the inner periphery 142 of the optical spacer 14 includes an inner surface 1426 (e.g., an inclined surface), which is provided with radial microstructures. FIG. 5i is a schematic plan view of the optical spacer of the lens module according to the ninth embodiment of the present disclosure. Referring to FIG. 5 and FIG. 5i, the inner periphery 142 of the optical spacer 14 includes an inner surface 1426 (e.g., an inclined surface), which is provided with V-shaped microstructures. The optical spacer of the present disclosure is provided with a microstructure on the inner surface of the inner periphery, which can scatter stray light by using the special microstructures to improve an image quality of the lens module.

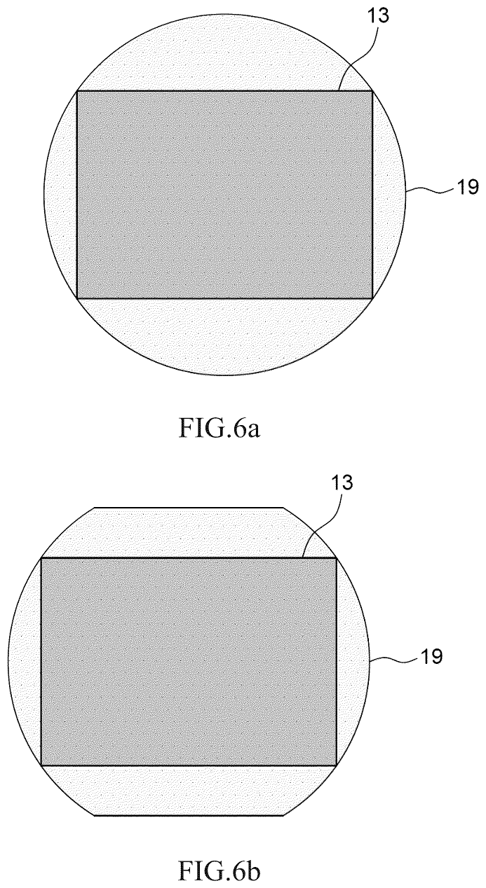

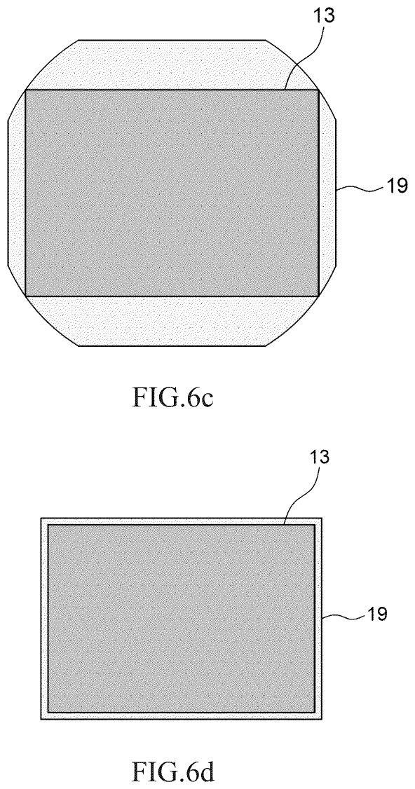

FIG. 6a to FIG. 6d are schematic diagrams showing four relationships between the size of the optical sensor and an imaging area of the lens module according to an embodiment of the present disclosure. The size of the optical sensor 13 is usually set to an aspect ratio of 3:4 or 9:16, but is not limited thereto; and the imaging area 19 is usually larger than the size of the optical sensor 13. Referring to FIG. 6a, when the size of the lens module is only reduced to the position outside the lens barrel, the imaging area 19 is still a complete circle without sacrificing the range of the imaging area 19. Referring to FIG. 6b and FIG. 4, when the size of the lens module is reduced along the Y-axis to the position of the non-optical area of the optical lens assembly, part of the range of the imaging area 19 in the specific direction of the Y-axis is sacrificed. Referring to FIG. 6c and FIG. 4, when the size of the lens module is reduced along the Y-axis and X-axis to the position of the non-optical area of the optical lens assembly, part of the imaging area 19 in the specific directions of the Y-axis and X-axis is sacrificed. Referring to FIG. 6d and FIG. 4, when the size of the lens module is reduced along the Y-axis and X-axis to the position of the non-optical area of the optical lens assembly, most of the imaging area 19 in the specific directions of the Y-axis and X-axis is sacrificed.

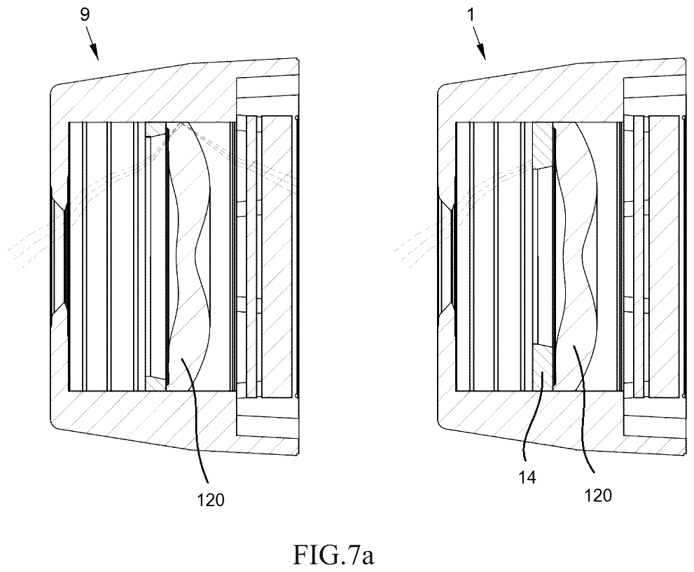

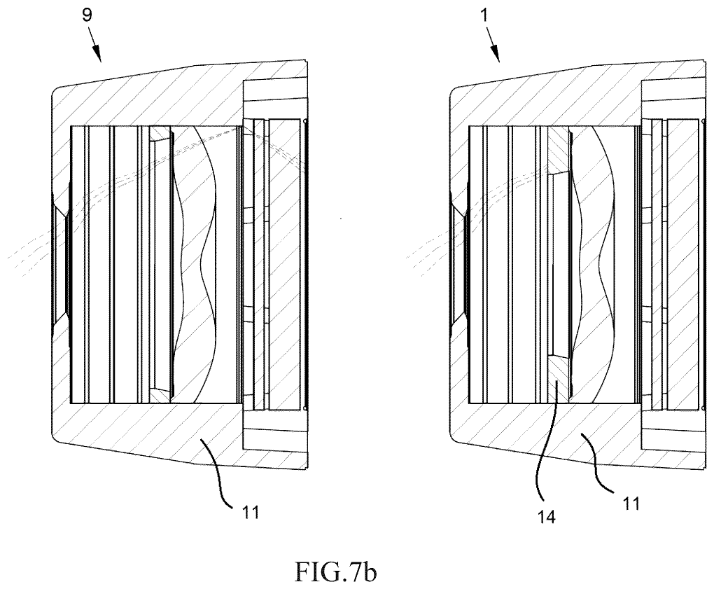

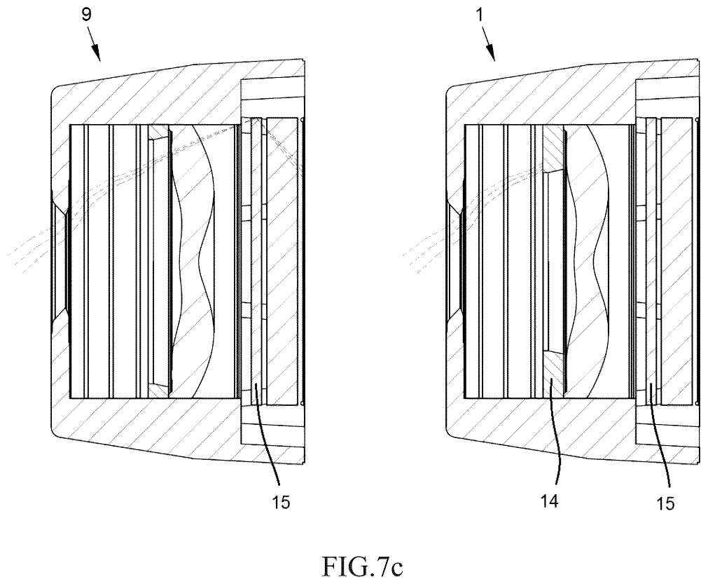

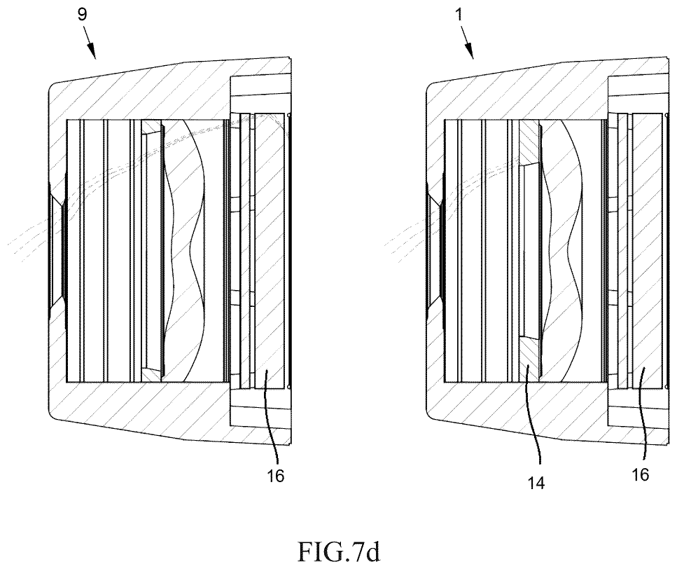

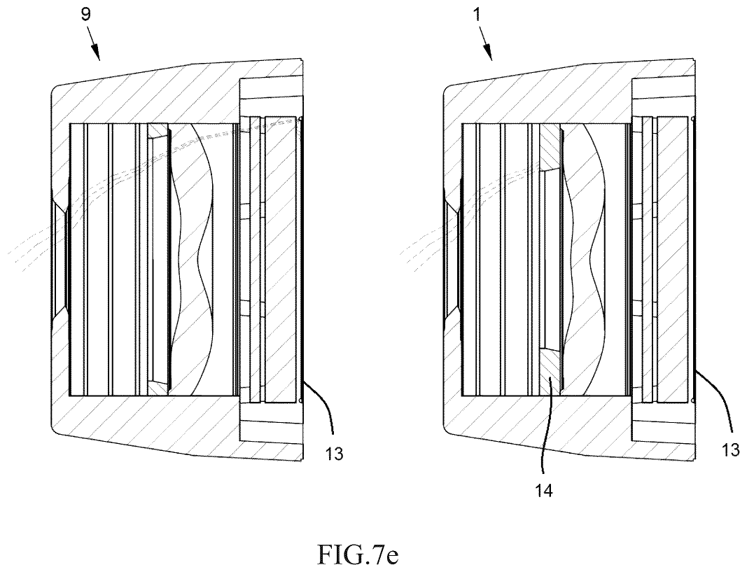

FIG. 7a to FIG. 7e are schematic diagrams comparing the lens module in the prior art with the lens module in other embodiments of the present disclosure. Referring to FIG. 7a, a path of the stray light of the lens module 9 in the prior art reaches an outside of the lens 120, but the lens module 1 of the present disclosure solves the problem of the stray light hitting the outside of the lens 120. Referring to FIG. 7b, a path of the stray light of the lens module 9 in the prior art reaches a side wall of the lens barrel 11, but the lens module 1 of the present disclosure solves the problem of the stray light hitting the side wall of the lens barrel 11. Referring to FIG. 7c, a path of the stray light of the lens module 9 in the prior art reaches a side wall of the optical filter 15, but the lens module 1 of the present disclosure solves the problem of the stray light hitting the side wall of the optical filter 15. Referring to FIG. 7d, a path of the stray light of the lens module 9 in the prior art reaches a side wall of the protective glass sheet 16, but the lens module 1 of the present disclosure solves the problem of the stray light hitting the side wall of the protective glass sheet 16. Referring to FIG. 7e, a path of the stray light of the lens module 9 in the prior art reaches a gold wire of the optical sensor 13, but the lens module 1 of the present disclosure solves the problem of the stray light hitting the gold wire of the optical sensor 13. When the optical spacer 14 of the present disclosure is designed according to the above embodiments, the optical spacer 14 can block the stray light at a large angle. The stray light are intercepted to improve image quality, before the stray light hit the outside of the lens 120, the side wall of the lens barrel 11, the side wall of the optical filter 15, and the side wall of the protective glass sheet 16 or the gold wire of the optical sensor 13. Therefore, the optical spacer of the present disclosure has a non-traditional annular structure in a specific direction, which can solve the problem of the stray light in a specific direction of the Y-axis or X-axis and improve an image quality of the lens module.

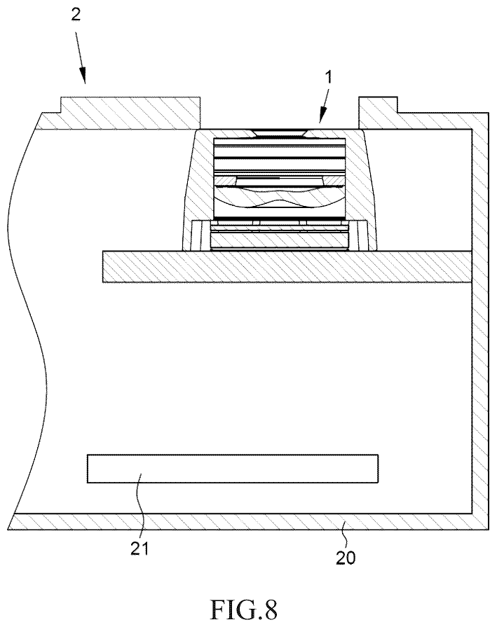

FIG. 8 is a schematic sectional view of an electronic device according to an embodiment of the present disclosure. The electronic device 2 includes: a housing 20, the lens module 1 of the present disclosure, and a control component 21. The lens module 1 is disposed in the housing 20. The control component 21 is disposed in the housing 20 and is electrically connected to the optical sensor of the lens module 1. The electronic device 2 of the present disclosure can be a mobile phone, a laptop, etc. In addition, the lens module provided by the present disclosure may be used in photography, surveillance, automation equipment, vehicle surround systems, and electronic imaging systems in the internet of things (IOT) equipment, but is not limited thereto.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. A lens module, defining a central axis, an X axis, a Y axis, an object side and an image side, wherein the central axis, the X axis and the Y axis are perpendicular to each other, the image side is opposite to the object side, and the lens module comprises:
a lens barrel;
an optical lens assembly disposed in the lens barrel, wherein the optical lens assembly includes at least one lens;
an optical spacer disposed in the lens barrel and located on an object-side surface of the lens; and
an optical sensor disposed in the lens barrel and located on an image plane;
wherein the optical spacer includes an annular body having an outer periphery and an inner periphery, the outer periphery surrounds the inner periphery, and an opening is formed around the inner periphery;
the outer periphery includes first and second cut edges, which are respectively contracted toward a center of the optical spacer along the Y-axis, and the inner periphery includes third and fourth cut edges, which are respectively contracted toward the center of the optical spacer along the Y-axis; and
the distance between the first and second cut edges is D2, the distance between the third and fourth cut edges is D1, and the following conditions are satisfied: 0.05≤D1/D2≤0.95.

2. The lens module according to claim 1, wherein all of the first to fourth cut sides have a flat surface.

3. The lens module according to claim 1, wherein the inner periphery further includes four corners, which respectively expand in opposite directions toward the center of the optical spacer.

4. The lens module according to claim 3, wherein both of the third and fourth cut edges have a wavy surface.

5. The lens module according to claim 1, wherein the outer periphery further includes fifth and sixth cut edges, which are respectively contracted toward the center of the optical spacer along the X-axis, and the inner spacer further includes seventh and eighth cut edges, which are respectively contracted toward the center of the optical spacer along the X-axis.

6. The lens module according to claim 5, wherein all of the third, fourth, seventh and eighth cut edges have a wavy surface.

7. The lens module according to claim 6, wherein the inner periphery further includes four corners, respectively forming diagonal arcs.

8. The lens module according to claim 5, wherein all of the third, fourth, seventh and eighth cut edges have an arc-shaped surface, and the inner periphery further includes four corners, each of which expands in the opposite direction toward the center of the optical spacer to form a transmission portion.

9. The lens module according to claim 1, wherein the inner periphery includes an inner surface provided with concentric annular microstructures, radial microstructures, or V-shaped microstructures.

10. An electronic device, comprising:
a housing;
a lens module disposed in the housing, wherein:
the lens module defines a central axis, an X axis, a Y axis, an object side and an image side, wherein the central axis, the X axis and the Y axis are perpendicular to each other, the image side is opposite to the object side, and the lens module comprises:
a lens barrel;
an optical lens assembly disposed in the lens barrel, wherein the optical lens assembly includes at least one lens;
an optical spacer disposed in the lens barrel and located on an object-side surface of the lens; and
an optical sensor disposed in the lens barrel and located on an image plane;
wherein the optical spacer includes an annular body having an outer periphery and an inner periphery, the outer periphery surrounds the inner periphery, and an opening is formed around the inner periphery;
the outer periphery includes first and second cut edges, which are respectively contracted toward a center of the optical spacer along the Y-axis, and the inner periphery includes third and fourth cut edges, which are respectively contracted toward the center of the optical spacer along the Y-axis; and
the distance between the first and second cut edges is D2, the distance between the third and fourth cut edges is D1, and the following conditions are satisfied: 0.05≤D1/D2≤0.95; and
a control component disposed in the housing and electrically connected to the optical sensor.

11. The electronic device according to claim 10, wherein all of the first to fourth cut sides have a flat surface.

12. The electronic device according to claim 10, wherein the inner periphery further includes four corners, which respectively expand in opposite directions toward the center of the optical spacer.

13. The electronic device according to claim 12, wherein both of the third and fourth cut edges have a wavy surface.

14. The electronic device according to claim 10, wherein the outer periphery further includes fifth and sixth cut edges, which are respectively contracted toward the center of the optical spacer along the X-axis, and the inner spacer further includes seventh and eighth cut edges, which are respectively contracted along the X-axis toward the center of the optical spacer.

15. The electronic device according to claim 14, wherein all of the third, fourth, seventh and eighth cut edges have a wavy surface.

16. The electronic device according to claim 15, wherein the inner periphery further includes four corners, respectively forming diagonal arcs.

17. The electronic device according to claim 14, wherein all of the third, fourth, seventh and eighth cut edges have an arc-shaped surface, and the inner periphery further includes four corners, each of which expands in the opposite direction toward the center of the optical spacer to form a transmission portion.

18. The electronic device according to claim 10, wherein the inner periphery includes an inner surface provided with concentric annular microstructures, radial microstructures, or V-shaped microstructures.
